(19) United States
(12) Patent Application Publication
(10) Pub. No.: US 2010/0053827 A1
(43) Pub. Date: Mar. 4, 2010

(54) PROTECTION CIRCUIT

(76) Inventor: Harumi KAWANO, Miyazaki (JP)

Correspondence Address: Kubotera & Associates, LLC, 200 Daingerfield Rd, Suite 202, Alexandria, VA, 22314, US

(21) Appl. No.: 12/498,441

(22) Filed: Jul. 7, 2009

(30) Foreign Application Priority Data
Aug. 28, 2008 (JP) 2008-205880

(51) Int. Cl. H02H 9/04

(52) U.S. Cl. 361/56

(57) ABSTRACT

A protection circuit includes a first primary-type transistor; a secondary-type transistor; a circuit protection element; and a second primary-type transistor. The first primary-type transistor includes a drain terminal connected to a first terminal to which a first voltage is applied. The first primary-type transistor further includes a gate terminal, a source terminal, and a bulk terminal each connected to a second terminal to which a second voltage is applied. The first primary-type transistor responds to an excessive voltage applied to the first terminal as a forward direction response to discharge the excessive voltage to the second terminal, thereby protecting an internal circuit from the excessive voltage.

### BACKGROUND OF THE INVENTION AND RELATED ART STATEMENT

The present invention relates to a protection circuit. More specifically, the present invention relates to a protection circuit connected to a terminal of an LSI (Large Scale Integration) for preventing a transistor in the LSI from being damaged due to static electricity.

A conventional protection circuit is connected to an output/input terminal of an LSI for protecting an internal circuit of the LSI. FIG. 8 is a circuit diagram showing the conventional protection circuit. As shown in FIG. 8, the conventional protection circuit includes two protection transistors, i.e., a PMOS transistor P1 and an NMOS transistor N1.

In the conventional protection circuit shown in FIG. 8, a power source terminal 2 with a potential VDD is connected to gate, source, and bulk terminals of the PMOS transistor P1, and a drain terminal of the PMOS transistor P1 is connected to an input (IN) terminal 1. When the conventional protection circuit is operating in a normal state, the PMOS transistor P1 is in an off state. A ground (GND) terminal 3 with a ground potential is connected to gate, source, and bulk terminals of the NMOS transistor N1, and a drain terminal of the NMOS transistor N1 is connected to the input terminal (IN) 1. When the conventional protection circuit is operating in the normal state, the NMOS transistor N1 is in an off state. The input terminal 1 is connected to an internal circuit 4.

FIG. 9 is a graph showing a current-voltage property of the conventional protection circuit shown in FIG. 8. An operation of the conventional protection circuit when an excessive voltage is applied thereto will be explained with reference to FIG. 9.

When a voltage pulse with a positive polarity is applied to the input terminal 1 with the power source terminal 2 at the ground potential, the PMOS transistor P1 responds with a voltage Vthp (a diode between the drain terminal and the bulk terminal is turned on). Accordingly, the voltage pulse thus applied is discharged to the power source terminal 2 from the drain terminal through the bulk terminal of the PMOS transistor P1. The protection operation is referred to as a forward direction response of the PMOS transistor P1.

Similarly, when a voltage pulse with a negative polarity is applied to the input terminal 1 with the power source terminal 2 at the ground potential, the PMOS transistor P1 responds with a voltage V1p. Accordingly, the voltage pulse thus applied is discharged to the power source terminal 2 from the drain terminal through the source terminal of the PMOS transistor P1. The protection operation is referred to as a reverse direction response of the PMOS transistor P1.

When a voltage pulse with a positive polarity is applied to the input terminal 1 with the GND terminal 3 at the ground potential, the NMOS transistor N1 responds with a voltage V1n. Accordingly, the voltage pulse thus applied is discharged to the GND terminal 3 from the drain terminal through the source terminal of the NMOS transistor N1. The protection operation is referred to as a reverse direction response of the NMOS transistor N1.

Similarly, when a voltage pulse with a negative polarity is applied to the input terminal 1 with the GND terminal 3 at the ground potential, the NMOS transistor N1 responds with a voltage Vthn. Accordingly, the voltage pulse thus applied is discharged to the GND terminal 3 from the drain terminal through the bulk terminal of the NMOS transistor N1. The protection operation is referred to as a forward direction response of the NMOS transistor N1.

As described above, when an excessive voltage causing electrostatic breakdown of an LSI is applied to the input terminal 1, the excessive voltage is discharged through the protection operation, thereby protecting the internal circuit. In FIG. 9, a response property of the PMOS transistor P1 is represented with a solid line, and a response property of the NMOS transistor N1 is represented with a hidden line. The forward direction response of the PMOS transistor P1 is represented with “TLP_P_+”, and the reverse direction response of the PMOS transistor P1 is represented with “TLP_P_−”. The forward direction response of the NMOS transistor N1 is represented with “TLP_N_+”, and the reverse direction response of the NMOS transistor N1 is represented with “TLP_N_−”.

In the conventional protection circuit, the response voltage V1p of the PMOS transistor P1 and the response voltage V1n of the NMOS transistor N1 are referred to as a snapback voltage. Once the applied voltage exceeds the snapback voltage, the transistor breaks down and becomes an on state, so that a current I flows through a bypass path for discharge. In general, the response voltage V1p and the response voltage V1n (the snapback voltages) in the reverse direction are greater than the response voltage Vthp and the response voltage Vthn in the forward direction, sometimes about 10 to 20 times greater depending on a manufacturing process of the conventional protection circuit.

In recent years, as a size of the LSI decreases, a transistor of an internal circuit to be protected has a gate insulation film with a smaller thickness, thereby lowering a withstand voltage of the transistor. Accordingly, in a configuration in which a bypass path is formed through breakdown of a transistor, it is difficult to obtain a sufficient snapback voltage for withstanding a voltage applied to the transistor of the internal circuit.

Patent Reference has disclosed a conventional signal input circuit (protection circuit). In the conventional signal input circuit, protection diodes are disposed between a signal input terminal and a power source terminal VDD, and between the signal input terminal and a power source terminal VSS, respectively. Further, a protection transistor with a source terminal and a gate terminal thereof connected to each other is disposed between a power source line connected to the VDD power source terminal and a power source line connected to the VSS power source terminal.

In the conventional signal input circuit described above, when an excessive voltage in a reverse direction is applied thereto, a bypass path is formed through breakdown of the protection transistor. The protection transistor is disposed at a specific connection position to set a snapback voltage, so that the snapback voltage does not exceed a withstanding voltage of the protection transistor of the conventional signal input circuit.

Patent Reference: Japanese Patent Publication No. 10-214905

In the conventional signal input circuit disclosed in Patent Reference, the bypass path is formed through breakdown of the protection transistor. Accordingly, it is necessary to control the snapback voltage through adjusting a film thickness of a gate protection film. Further, when the snapback voltage is set less than a power source voltage VDD, a leak current tends to flow between two power source terminals to which the power source voltage VDD and a power source voltage VSS are applied.

In view of the problems described above, an object of the present invention is to provide a protection circuit capable of forming a bypass path upon receiving a voltage sufficiently smaller than a withstanding voltage of a transistor of an internal circuit to be protected, thereby discharging an excessive voltage.

Further objects and advantages of the invention will be apparent from the following description of the invention.

### SUMMARY OF THE INVENTION

In order to attain the objects described above, according to a first aspect of the present invention, a protection circuit includes a first primary-type transistor; a secondary-type transistor; a circuit protection element; and a second primary-type transistor. The first primary-type transistor includes a drain terminal connected to a first terminal to which a first voltage is applied. The first primary-type transistor further includes a gate terminal, a source terminal, and a bulk terminal each connected to a second terminal to which a second voltage is applied. The first primary-type transistor responds to an excessive voltage applied to the first terminal as a forward direction response to discharge the excessive voltage to the second terminal, thereby protecting an internal circuit from the excessive voltage.

In the first aspect of the present invention, the secondary-type transistor includes a drain terminal connected to the first terminal. The secondary-type transistor further includes a gate terminal, a source terminal, and a bulk terminal each connected to a third terminal to which a third voltage is applied. The secondary-type transistor responds to the excessive voltage applied to the first terminal as a forward direction response to discharge the excessive voltage to the third terminal, thereby protecting the internal circuit from the excessive voltage.

In the first aspect of the present invention, the circuit protection element is disposed closer to a side of the internal circuit relative to the first primary-type transistor. The circuit protection element includes two terminals, one of the terminals connected to the first terminal and the other one of the terminals connected to the second terminal through a first resistor. The circuit protection element responds to the excessive voltage applied to the first terminal as a forward direction response to discharge the excessive voltage from the other one of the terminals, thereby protecting the internal circuit from the excessive voltage.

In the first aspect of the present invention, the second primary-type transistor includes a drain terminal connected to the third terminal. The second primary-type transistor further includes a source terminal and a bulk terminal each connected to the other one of the terminals of the circuit protection element. The second primary-type transistor further includes a gate terminal connected to the second terminal through a second resistor. The second primary-type transistor discharges the excessive voltage discharged from the circuit protection element to the third terminal, thereby protecting the internal circuit from the excessive voltage.

According to a second aspect of the present invention, in the protection circuit in the first aspect, the circuit protection element is formed a third primary-type transistor. The third primary-type transistor includes a drain terminal as the one of the terminals connected to the first terminal. The third primary-type transistor further includes a gate terminal and a source terminal each connected to the second terminal. The third primary-type transistor further includes a bulk terminal as the other one of the terminals connected to the second terminal through the first resistor.

According to a third aspect of the present invention, in the protection circuit in the first aspect, the circuit protection element is formed a protection diode. The protection diode includes a p-side terminal as the one of the terminals connected to the first terminal. The protection diode further includes an n-side terminal as the other one of the terminals connected to the second terminal through the first resistor.

According to a fourth aspect of the present invention, a protection circuit includes a first PMOS transistor; a first NMOS transistor; a second PMOS transistor; and a third PMOS transistor. The first PMOS transistor includes a drain terminal connected to a first terminal to which a first voltage is applied. The first PMOS transistor further includes a gate terminal, a source terminal, and a bulk terminal each connected to a second terminal to which a second voltage is applied. The first PMOS transistor responds to an excessive voltage applied to the first terminal as a forward direction response to discharge the excessive voltage to the second terminal, thereby protecting an internal circuit from the excessive voltage.

In the fourth aspect of the present invention, the first NMOS transistor includes a drain terminal connected to the first terminal. The first NMOS transistor further includes a gate terminal, a source terminal, and a bulk terminal each connected to a third terminal to which a third voltage is applied. The first NMOS transistor responds to the excessive voltage applied to the first terminal as a forward direction response to discharge the excessive voltage to the third terminal, thereby protecting the internal circuit from the excessive voltage.

In the fourth aspect of the present invention, the second PMOS transistor is disposed closer to a side of the internal circuit in parallel to the first PMOS transistor. The second PMOS transistor includes a drain terminal connected to the first terminal. The second PMOS transistor further includes a gate terminal and a source terminal each connected to the second terminal. The second PMOS transistor further includes a bulk terminal connected to the second terminal through a first resistor. The second PMOS transistor responds to the excessive voltage applied to the first terminal as a forward direction response to discharge the excessive voltage from the bulk terminal thereof, thereby protecting the internal circuit from the excessive voltage.

In the fourth aspect of the present invention, the third PMOS transistor includes a drain terminal connected to the third terminal. The third PMOS transistor further includes a source terminal and a bulk terminal each connected to the bulk terminal of the second PMOS transistor. The third PMOS transistor further includes a gate terminal connected to the second terminal through a second resistor. The third PMOS transistor discharges the excessive voltage discharged from the bulk terminal of the second PMOS transistor to the third terminal, thereby protecting the internal circuit from the excessive voltage.

According to a fifth aspect of the present invention, a protection circuit includes a first PMOS transistor; a first NMOS transistor; a second NMOS transistor; and a third NMOS transistor. The first PMOS transistor includes a drain terminal connected to a first terminal to which a first voltage is applied. The first PMOS transistor further includes a gate terminal, a source terminal, and a bulk terminal each connected to a second terminal to which a second voltage is applied. The first PMOS transistor responds to an excessive voltage applied to the first terminal as a forward direction response to discharge the excessive voltage to the second terminal, thereby protecting an internal circuit from the excessive voltage.

In the fifth aspect of the present invention, the first NMOS transistor includes a drain terminal connected to the first terminal. The first NMOS transistor further includes a gate terminal, a source terminal, and a bulk terminal each connected to a third terminal to which a third voltage is applied. The first NMOS transistor responds to the excessive voltage applied to the first terminal as a forward direction response to discharge the excessive voltage to the third terminal, thereby protecting the internal circuit from the excessive voltage.

In the fifth aspect of the present invention, the second NMOS transistor is disposed closer to a side of the internal circuit in parallel to the first NMOS transistor. The second NMOS transistor includes a drain terminal connected to the first terminal. The second NMOS transistor further includes a gate terminal and a source terminal each connected to the second terminal. The second NMOS transistor further includes a bulk terminal connected to the second terminal through a first resistor. The second NMOS transistor responds to the excessive voltage applied to the first terminal as a forward direction response to discharge the excessive voltage from the bulk terminal, thereby protecting the internal circuit from the excessive voltage.

In the fifth aspect of the present invention, the third NMOS transistor includes a drain terminal connected to the second terminal. The third NMOS transistor further includes a source terminal and a bulk terminal each connected to the bulk terminal of the second NMOS transistor. The third NMOS transistor further includes a gate terminal connected to the third terminal through a second resistor. The third NMOS transistor discharges the excessive voltage discharged from the bulk terminal of the second NMOS transistor to the second terminal, thereby protecting the internal circuit from the excessive voltage.

According to a sixth aspect of the present invention, a protection circuit includes a first PMOS transistor; a first NMOS transistor; a second PMOS transistor; a third PMOS transistor; a second NMOS transistor; and a third NMOS transistor. The first PMOS transistor includes a drain terminal connected to a first terminal to which a first voltage is applied. The first PMOS transistor further includes a gate terminal, a source terminal, and a bulk terminal each connected to a second terminal to which a second voltage is applied. The first PMOS transistor responds to an excessive voltage applied to the first terminal as a forward direction response to discharge the excessive voltage to the second terminal, thereby protecting an internal circuit from the excessive voltage.

In the sixth aspect of the present invention, the first NMOS transistor includes a drain terminal connected to the first terminal. The first NMOS transistor further includes a gate terminal, a source terminal, and a bulk terminal each connected to a third terminal to which a third voltage is applied. The first NMOS transistor responds to the excessive voltage applied to the first terminal as a forward direction response to discharge the excessive voltage to the third terminal, thereby protecting the internal circuit from the excessive voltage.

In the sixth aspect of the present invention, the second PMOS transistor is disposed closer to a side of the internal circuit in parallel to the first PMOS transistor. The second PMOS transistor includes a drain terminal connected to the first terminal. The second PMOS transistor further includes a gate terminal and a source terminal each connected to the second terminal. The second PMOS transistor further includes a bulk terminal connected to the second terminal through a first resistor. The second PMOS transistor responds to the excessive voltage applied to the first terminal as a forward direction response to discharge the excessive voltage from the bulk terminal thereof, thereby protecting the internal circuit from the excessive voltage.

In the sixth aspect of the present invention, the third PMOS transistor includes a drain terminal connected to the third terminal. The third PMOS transistor further includes a source terminal and a bulk terminal each connected to the bulk terminal of the second PMOS transistor. The third PMOS transistor further includes a gate terminal connected to the second terminal through a second resistor. The third PMOS transistor discharges the excessive voltage discharged from the bulk terminal of the second PMOS transistor to the third terminal, thereby protecting the internal circuit from the excessive voltage.

In the sixth aspect of the present invention, the second NMOS transistor is disposed closer to a side of the internal circuit in parallel to the first NMOS transistor. The second NMOS transistor includes a drain terminal connected to the first terminal. The second NMOS transistor further includes a gate terminal and a source terminal each connected to the third terminal. The second NMOS transistor further includes a bulk terminal connected to the third terminal through a third resistor. The second NMOS transistor responds to the excessive voltage applied to the first terminal as a forward direction response to discharge the excessive voltage from the bulk terminal thereof, thereby protecting the internal circuit from the excessive voltage.

In the sixth aspect of the present invention, the third NMOS transistor includes a drain terminal connected to the second terminal. The third NMOS transistor further includes a source terminal and a bulk terminal each connected to the bulk terminal of the second NMOS transistor. The third NMOS transistor further includes a gate terminal connected to the third terminal through a fourth resistor. The third NMOS transistor discharges the excessive voltage discharged from the bulk terminal of the second NMOS transistor to the second terminal, thereby protecting the internal circuit from the excessive voltage.

In the present invention, breakdown of a transistor is not utilized. Accordingly, it is possible to form a bypass path upon receiving a voltage sufficiently smaller than a withstanding voltage of the transistor of the internal circuit to be protected, thereby discharging an excessive voltage. Further, as compared with the case of utilizing breakdown of a transistor, it is not necessary to adjust a snapback voltage.

### BRIEF DESCRIPTION OF THE DRAWINGS

FIG. 1 is a circuit diagram showing a protection circuit according to a first embodiment of the present invention;

FIG. 2 is a circuit diagram showing an operation of the protection circuit according to the first embodiment of the present invention;

FIG. 3 is a circuit diagram showing a protection circuit according to a second embodiment of the present invention;

FIG. 4 is a circuit diagram showing an operation of the protection circuit according to the second embodiment of the present invention;

FIG. 5 is a circuit diagram showing a protection circuit according to a third embodiment of the present invention;

FIG. 6 is a circuit diagram showing a protection circuit according to a fourth embodiment of the present invention;

FIG. 7 is a circuit diagram showing an operation of the protection circuit according to the fourth embodiment of the present invention;

FIG. 8 is a circuit diagram showing a conventional protection circuit; and

FIG. 9 is a graph showing a current-voltage property of the conventional protection circuit shown in FIG. 8.

### DETAILED DESCRIPTION OF PREFERRED EMBODIMENTS

Hereunder, embodiments of the present invention will be explained with reference to the accompanying drawings.

### First Embodiment

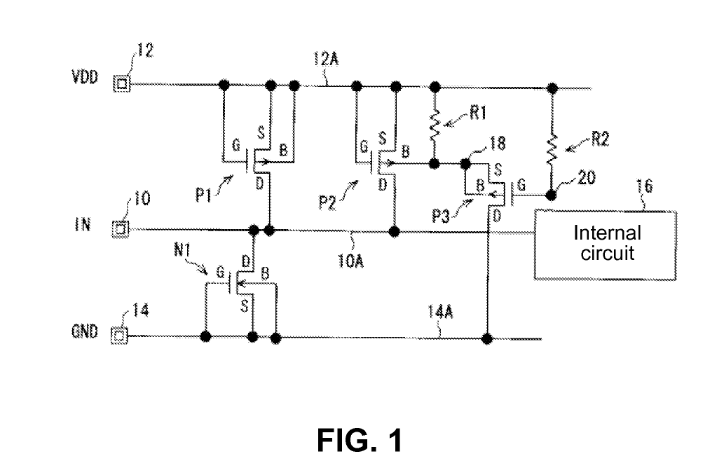

A first embodiment of the present invention will be explained. FIG. 1 is a circuit diagram showing a protection circuit according to the first embodiment of the present invention.

As shown in FIG. 1, the protection circuit includes a signal input terminal (IN) 10; a power source terminal (VDD) 12 with a voltage VDD; and a ground terminal (GND) 14. A signal input line 10A is connected to the signal input terminal 10. The signal input terminal 10 is provided for inputting a signal to an internal circuit 16 of an LSI (Large Scale Integration) through the signal input line 10A. A power source line 12A is connected to the power source terminal 12, and a GND line 14A is connected to the GND terminal 14.

In the embodiment, the protection circuit includes a PMOS transistor P1; an NMOS transistor N1; a PMOS transistor P2; and a PMOS transistor P3 as protection transistors for protecting the internal circuit 16 from an excessive voltage. Each of the PMOS transistor P1, the NMOS transistor N1, the PMOS transistor P2, and the PMOS transistor P3 includes a gate terminal (G), a source terminal (S), a drain terminal (D), and a bulk terminal (B).

In the embodiment, the PMOS transistor P1 has the gate terminal (G), the source terminal (S), and the bulk terminal (B) connected to the power source line 12A. The drain terminal (D) of the PMOS transistor P1 is connected to the signal input line 10A. Further, the NMOS transistor N1 has the gate terminal (G), the source terminal (S), and the bulk terminal (B) connected to the GND line 14A. The drain terminal (D) of the NMOS transistor N1 is connected to the signal input line 10A.

In the embodiment, the PMOS transistor P2 has the gate terminal (G) and the source terminal (S) connected to the power source line 12A. The drain terminal (D) of the PMOS transistor P2 is connected to the signal input line 10A. The bulk terminal (B) of the PMOS transistor P2 is connected to the source terminal (S) and the bulk terminal (B) of the PMOS transistor P3 through a node 18. A resistor R1 is disposed between the node 18 and the power source terminal 12. The resistor R1 is connected to the node 18 and the power source line 12A, respectively.

In the embodiment, the drain terminal (D) of the PMOS transistor P3 is connected to the GND line 14A, and the gate terminal (G) thereof is connected to the power source line 12A through a node 20 and a resistor R2. In other words, the resistor R2 is disposed between the node 20 and the power source terminal 12. The resistor R2 is connected to the node 20 and the power source line 12A, respectively.

In the embodiment, the resistor R1 and the resistor R2 have large resistivity, so that the node 18, the node 20, and the power source line 12A does not respond immediately. Further, the PMOS transistor P2 and the PMOS transistor P3 are formed in an n-well (an n-type region) electrically isolated from an n-well where other PMOS transistors including the PMOS transistor P1 are formed. Accordingly, the PMOS transistor P2 and the PMOS transistor P3 are independent from other PMOS transistors.

When the protection circuit operates normally, the node 18 has a potential the same as that of the power source terminal 12. Accordingly, the gate terminal, the source terminal, and the bulk terminal of the PMOS transistor P2 have a same potential, so that the PMOS transistor P2 is in an off state. Similarly, when the protection circuit operates normally, the node 20 has a potential the same as that of the power source terminal 12. Accordingly, the gate terminal, the source terminal, and the bulk terminal of the PMOS transistor P3 have a same potential, so that the PMOS transistor P3 is in an off state.

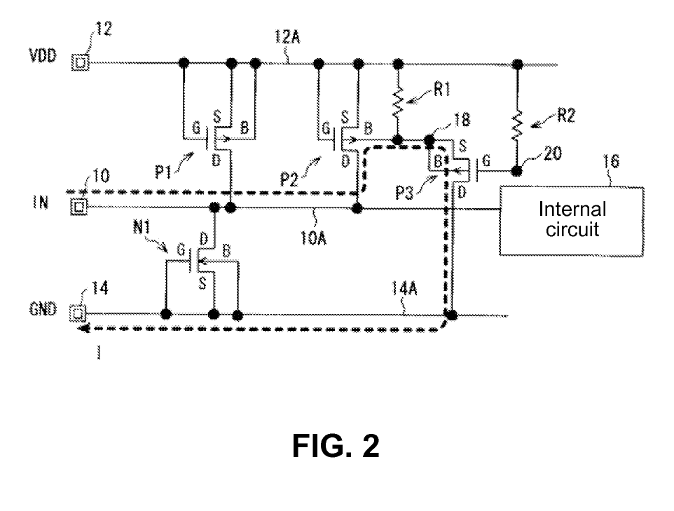

An operation of the protection circuit when an excessive voltage is applied to the protection circuit will be explained next. FIG. 2 is a circuit diagram showing the operation of the protection circuit according to the first embodiment of the present invention.

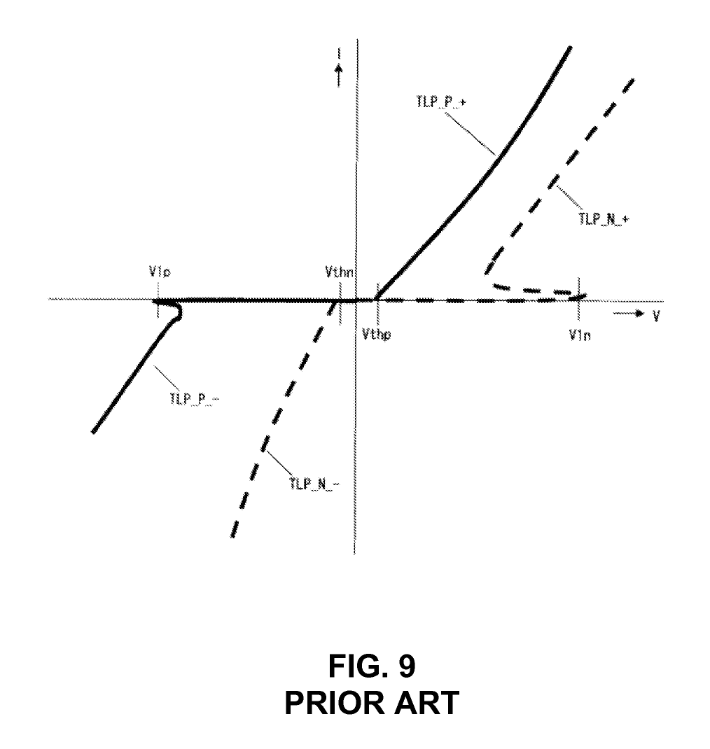

In the embodiment, it is supposed that each of the PMOS transistor P1, the PMOS transistor P2, and the PMOS transistor P3 responds at a voltage Vthp as a forward direction response and at a voltage V1p as a reverse direction response as shown in FIG. 9. In an actual case, each of the PMOS transistor P1, the PMOS transistor P2, and the PMOS transistor P3 responds at the voltage Vthp or the voltage V1p having a different value. For example, the response voltage Vthp of the PMOS transistor P2 in the forward direction response may be 0.3 V, and the response voltage Vthp of the PMOS transistor P2 in the forward direction response may be 0.7 V. Further, the NMOS transistor N1 responds at a voltage Vthn as a forward direction response and at a voltage V1n as a reverse direction response. As described above, the response voltage V1p and the response voltage V1n (snapback voltages) are substantially greater than the response voltage Vthp and the response voltage Vthn.

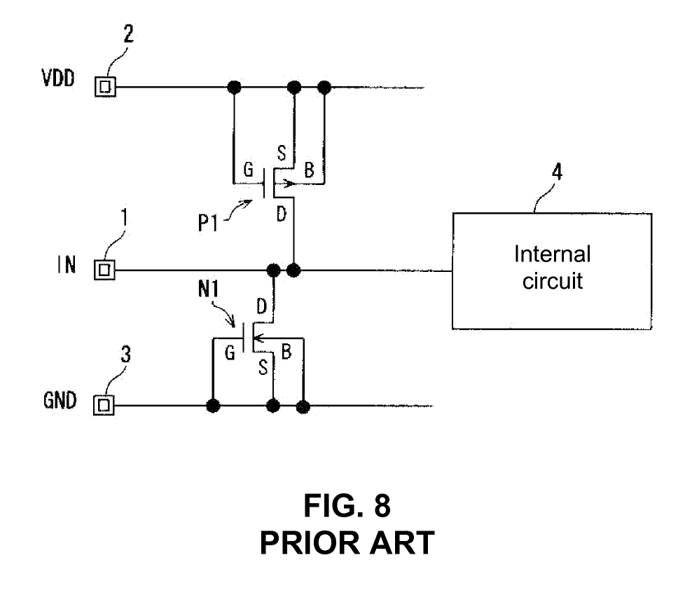

When a voltage pulse with a positive polarity is applied to the input terminal 10 with the power source terminal 12 at the ground potential, similar to the conventional protection circuit shown in FIG. 8, the PMOS transistor P1 responds with the voltage Vthp as the forward direction response (a diode between the drain terminal and the bulk terminal is turned on). At this moment, the GND terminal 14 becomes a floating state. Accordingly, the voltage pulse thus applied is discharged to the power source terminal 12 from the drain terminal through the bulk terminal of the PMOS transistor P1.

When a voltage pulse with a positive polarity is applied to the input terminal 10 with the GND terminal 14 at the ground potential, as shown in FIG. 2, the PMOS transistor P2 responds with the voltage Vthp as the forward direction response (a diode between the drain terminal and the bulk terminal is turned on). At this moment, the power source terminal 12 becomes a floating state. Accordingly, the voltage pulse thus applied is discharged to the node 18 from the drain terminal through the bulk terminal of the PMOS transistor P2. As described above, the resistor R1 has a high resistivity, so that a voltage of the node 18 increases and exceeds that of the node 20. Accordingly, the PMOS transistor P3 responds with the voltage Vthp (a diode between the drain terminal and the bulk terminal is turned on) as the forward direction response. As a result, the voltage pulse thus applied is discharged to the GND terminal 14 from the source terminal through the drain terminal of the PMOS transistor P3.

At this moment, the PMOS transistor P2 and the PMOS transistor P3 have the response voltage Vthp. Accordingly, it is possible to discharge the voltage pulse thus applied with double of the response voltage Vthp (Vthp+Vthp=2 Vthp). For example, when the response voltage Vthp of the PMOS transistor P2 is about 0.3 V and the response voltage Vthp of the PMOS transistor P2 is about 0.7 V, it is possible to discharge the voltage pulse thus applied with the response voltage of 1.0 V, i.e., a relatively low voltage. In other words, it is possible to respond with a voltage smaller than the response voltage V1n of the NMOS transistor N1 in the reverse direction response.

Note that when the forward direction voltage flows from the drain terminal through the bulk terminal of the PMOS transistor P2, the forward direction voltage flows from the drain terminal to the bulk terminal of the PMOS transistor P1 as well. Accordingly, a voltage at the source terminal of the PMOS transistor P3 (and the node 18) looks as if the voltage does not increase to turn on the PMOS transistor P3. To this end, in the protection circuit, the resistor R2 is provided such that a time difference is created in a voltage change between the node 18 and the node 20. Accordingly, the node 20 has a voltage smaller than that of the node 18, so that the PMOS transistor P3 is turned on.

As described above, in the embodiment, during the protection operation, in which an excessive voltage is applied to the protection circuit, when the excessive voltage is the voltage pulse with the positive polarity with the GND terminal 14 at the ground potential, a bypass path is formed through the forward direction response of the PMOS transistor P2 and the PMOS transistor P3. Accordingly, it is possible to discharge the voltage pulse with a low response voltage, i.e., the sum of the response voltages of the PMOS transistor P2 and the PMOS transistor P3.

As described above, with the protection circuit, it is possible to respond with a voltage smaller than the response voltage V1n of the NMOS transistor N1 in the reverse direction response. Accordingly, it is possible to discharge the excessive voltage with a voltage smaller than a withstanding voltage of the transistor of the internal circuit to be protected. As a result, as a thickness of a gate insulation film decreases as a recent trend, it is possible to effectively prevent the gate insulation film of the transistor to be protected from being damaged.

### Second Embodiment

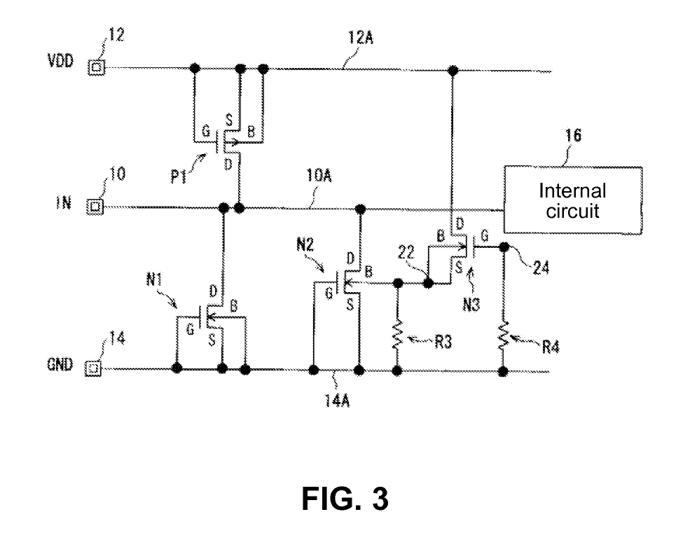

A second embodiment of the present invention will be explained next. FIG. 3 is a circuit diagram showing a protection circuit according to the second embodiment of the present invention.

As shown in FIG. 3, the protection circuit includes the PMOS transistor P1; the NMOS transistor N1; an NMOS transistor N2; and an NMOS transistor N3 as protection transistors. Components in the second embodiment similar to those in the first embodiment are designated with the same reference numerals, and explanations thereof are omitted.

In the embodiment, the NMOS transistor N2 has the gate terminal and the source terminal connected to the GND line 14A. The drain terminal of the NMOS transistor N2 is connected to the signal input line 10A. The bulk terminal of the NMOS transistor N2 is connected to the source terminal and the bulk terminal of the NMOS transistor N3 through a node 22. A resistor R3 is disposed between the node 22 and the GND terminal 14. The resistor R3 is connected to the node 22 and the GND line 14A, respectively.

In the embodiment, the drain terminal of the NMOS transistor N3 is connected to the power source line 12A, and the gate terminal thereof is connected to the GND line 14A through a node 24 and a resistor R4. In other words, the resistor R4 is disposed between the node 24 and the GND terminal 14. The resistor R4 is connected to the node 22 and the GND line 14A, respectively.

In the embodiment, the resistor R3 and the resistor R4 have large resistivity. Further, the NMOS transistor N2 and the NMOS transistor N3 are formed in a p-well (a p-type region) electrically isolated from a p-well where other NMOS transistors including the NMOS transistor N1 are formed. Accordingly, the NMOS transistor N2 and the NMOS transistor N3 are independent from other NMOS transistors.

When the protection circuit operates normally, the node 22 has a potential the same as that of the GND terminal 14. Accordingly, the gate terminal, the source terminal, and the bulk terminal of the NMOS transistor N2 have a same potential, so that the NMOS transistor N2 is in an off state. Similarly, when the protection circuit operates normally, the node 24 has a potential the same as that of the GND terminal 14. Accordingly, the gate terminal, the source terminal, and the bulk terminal of the NMOS transistor N3 have a same potential, so that the PMOS transistor P3 is in an off state.

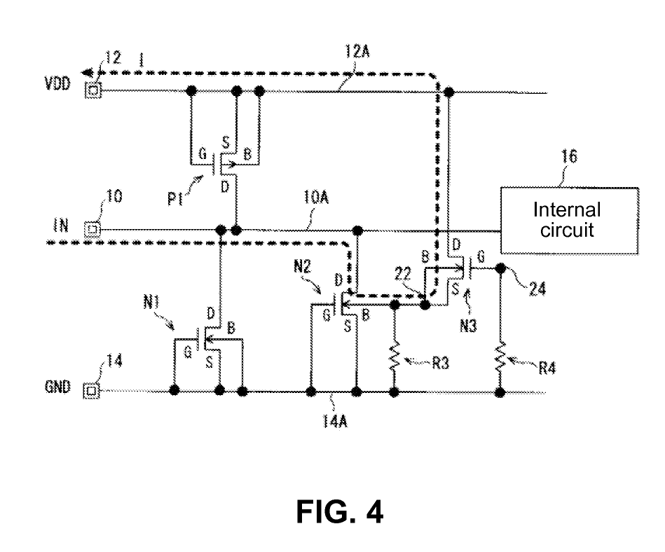

An operation of the protection circuit when an excessive voltage is applied to the protection circuit will be explained next. FIG. 4 is a circuit diagram showing the operation of the protection circuit according to the second embodiment of the present invention.

In the embodiment, it is supposed that the PMOS transistor P1 responds at the voltage Vthp as the forward direction response and at the voltage V1p as the reverse direction response as shown in FIG. 9. Further, each of the NMOS transistor N1, the NMOS transistor N2, and the NMOS transistor N3 responds at the voltage Vthn as the forward direction response and at the voltage V1n as the reverse direction response. In an actual case, each of the NMOS transistor N1, the NMOS transistor N2, and the NMOS transistor N3 responds at the voltage Vthn or the voltage V1n having a different value.

When a voltage pulse with a negative polarity is applied to the input terminal 10 with the GND terminal 14 at the ground potential, similar to the conventional protection circuit shown in FIG. 8, the NMOS transistor N1 responds with the voltage Vthn as the forward direction response. At this moment, the power source terminal 12 becomes the floating state. Accordingly, the voltage pulse thus applied is discharged to the GND terminal 14 from the drain terminal through the bulk terminal of the NMOS transistor N1.

When a voltage pulse with a negative polarity is applied to the input terminal 10 with the power source terminal 12 at the ground potential, as shown in FIG. 4, the NMOS transistor N2 responds with the voltage Vthn as the forward direction response. At this moment, the GND terminal 14 becomes the floating state. Accordingly, the voltage pulse thus applied is discharged to the node 22 from the drain terminal through the bulk terminal of the NMOS transistor N2. As described above, the resistor R3 has a high resistivity, so that a voltage of the node 22 increases and exceeds that of the node 24. Accordingly, the NMOS transistor N3 responds with the voltage Vthn as the forward direction response. As a result, the voltage pulse thus applied is discharged to the power source terminal 12 from the source terminal through the drain terminal of the NMOS transistor N3.

At this moment, the NMOS transistor N2 and the NMOS transistor N3 have the response voltage Vthn. Accordingly, it is possible to discharge the voltage pulse thus applied with double of the response voltage Vthn (Vthn+Vthn=2 Vthn). In other words, it is possible to respond with a voltage smaller than the response voltage V1p of the PMOS transistor P1 in the reverse direction response.

As described above, in the embodiment, during the protection operation, in which an excessive voltage is applied to the protection circuit, when the excessive voltage is the voltage pulse with the negative polarity with the power source terminal 12 at the ground potential, a bypass path is formed through the forward direction response of the NMOS transistor N2 and the NMOS transistor N3. Accordingly, it is possible to discharge the voltage pulse with a low response voltage, i.e., the sum of the response voltages of the NMOS transistor N2 and the NMOS transistor N3.

As described above, with the protection circuit, it is possible to respond with a voltage smaller than the response voltage V1p of the PMOS transistor P1 in the reverse direction response. Accordingly, it is possible to discharge the excessive voltage with a voltage smaller than a withstanding voltage of the transistor of the internal circuit to be protected. As a result, as a thickness of a gate insulation film decreases as a recent trend, it is possible to effectively prevent the gate insulation film of the transistor to be protected from being damaged.

### Third Embodiment

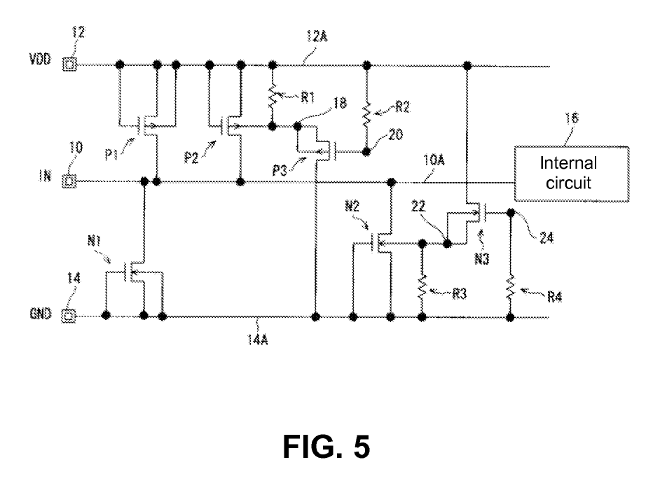

A third embodiment of the present invention will be explained next. FIG. 5 is a circuit diagram showing a protection circuit according to the third embodiment of the present invention.

As shown in FIG. 5, the protection circuit includes the PMOS transistor P1; the PMOS transistor P2; the PMOS transistor P3; the NMOS transistor N1; the NMOS transistor N2; and the NMOS transistor N3 as protection transistors. Components in the third embodiment similar to those in the first and second embodiments are designated with the same reference numerals, and explanations thereof are omitted.

When a voltage pulse with a positive polarity is applied to the input terminal 10 with the GND terminal 14 at the ground potential, the PMOS transistor P2 responds with the voltage Vthp as the forward direction response. Accordingly, the voltage pulse thus applied is discharged to the node 18 from the drain terminal through the bulk terminal of the PMOS transistor P2. At this moment, the PMOS transistor P3 responds with the voltage Vthp as the forward direction response. Accordingly, the voltage pulse thus applied is discharged to the GND terminal 14 from the drain terminal through the drain terminal of the PMOS transistor P3.

At this moment, the PMOS transistor P2 and the PMOS transistor P3 have the response voltage Vthp. Accordingly, it is possible to discharge the voltage pulse thus applied with double of the response voltage Vthn (Vthn+Vthn=2 Vthn). In other words, it is possible to respond with a voltage smaller than the response voltage V1n of the NMOS transistor N1 in the reverse direction response.

When a voltage pulse with a negative polarity is applied to the input terminal 10 with the power source terminal 12 at the ground potential, the NMOS transistor N2 responds with the voltage Vthn as the forward direction response. Accordingly, the voltage pulse thus applied is discharged to the node 22 from the drain terminal through the bulk terminal of the NMOS transistor N2. Further, the NMOS transistor N3 responds with the voltage Vthn as the forward direction response. Accordingly, the voltage pulse thus applied is discharged to the power source terminal 12 from the drain terminal through the drain terminal of the NMOS transistor N3.

At this moment, the NMOS transistor N2 and the NMOS transistor N3 have the response voltage Vthn. Accordingly, it is possible to discharge the voltage pulse thus applied with double of the response voltage Vthn (Vthn+Vthn=2 Vthn). In other words, it is possible to respond with a voltage smaller than the response voltage V1p of the PMOS transistor P1 in the reverse direction response.

As described above, in the embodiment, during the protection operation, in which an excessive voltage is applied to the protection circuit, when the excessive voltage is the voltage pulse with the positive polarity with the GND terminal 14 at the ground potential, a bypass path is formed through the forward direction response of the PMOS transistor P2 and the PMOS transistor P3. Accordingly, it is possible to discharge the voltage pulse with a low response voltage, i.e., the sum of the response voltages of the PMOS transistor P2 and the PMOS transistor P3.

Further, in the embodiment, during the protection operation, in which an excessive voltage is applied to the protection circuit, when the excessive voltage is the voltage pulse with the negative polarity with the power source terminal 12 at the ground potential, a bypass path is formed through the forward direction response of the NMOS transistor N2 and the NMOS transistor N3. Accordingly, it is possible to discharge the voltage pulse with a low response voltage, i.e., the sum of the response voltages of the NMOS transistor N2 and the NMOS transistor N3.

In either case, with the protection circuit, it is possible to respond with a voltage smaller than the response voltage in the reverse direction response. Accordingly, it is possible to discharge the excessive voltage with a voltage smaller than a withstanding voltage of the transistor of the internal circuit to be protected. As a result, as a thickness of a gate insulation film decreases as a recent trend, it is possible to effectively prevent the gate insulation film of the transistor to be protected from being damaged.

### Fourth Embodiment

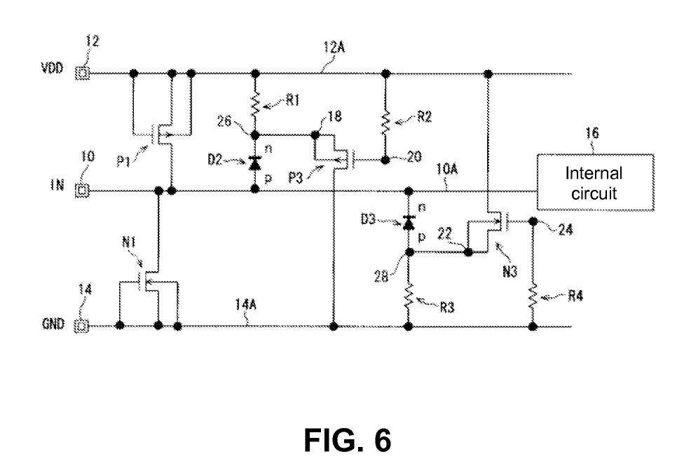

A fourth embodiment of the present invention will be explained next. FIG. 6 is a circuit diagram showing a protection circuit according to the fourth embodiment of the present invention.

As shown in FIG. 6, in the fourth embodiment, as opposed to the third embodiment, the PMOS transistor P2 is replaced with a protection diode D2, and the NMOS transistor N3 is replaced with a protection diode D3. Components in the fourth embodiment similar to those in the first to third embodiments are designated with the same reference numerals, and explanations thereof are omitted.

In the embodiment, the protection diode D2 has a p-side terminal connected to the signal input line 10A and an n-side terminal connected to the power source line 12A through a node 26 and the resistor R1. In other words, the protection diode D2 and the resistor R1 are connected in series between the signal input line 10A and the power source line 12A. Further, the protection diode D2 and the resistor R1 are connected in parallel to the PMOS transistor P1. Further, the n-side terminal of the protection diode D2 is connected to the source terminal and the bulk terminal of the PMOS transistor P3 through the node 26 and the node 18.

In the embodiment, the protection diode D3 has an n-side terminal connected to the signal input line 10A and a p-side terminal connected to the GND line 14A through a node 28 and the resistor R3. In other words, the protection diode D3 and the resistor R3 are connected in series between the signal input line 10A and the GND line 14A. Further, the protection diode D3 and the resistor R3 are connected in parallel to the NMOS transistor N1. Further, the p-side terminal of the protection diode D3 is connected to the source terminal and the bulk terminal of the NMOS transistor N3 through the node 28 and the node 22.

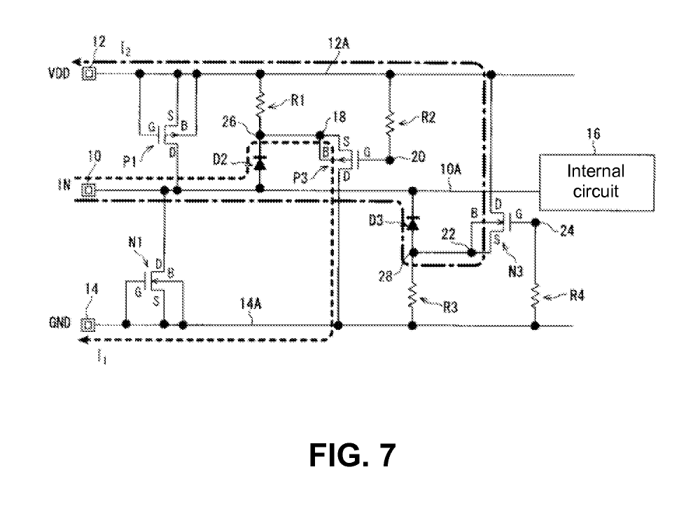

An operation of the protection circuit when an excessive voltage is applied to the protection circuit will be explained next. FIG. 7 is a circuit diagram showing the operation of the protection circuit according to the fourth embodiment of the present invention.

When a voltage pulse with a positive polarity is applied to the input terminal 10 with the GND terminal 14 at the ground potential, the protection diode D2 responds with a voltage Vd as the forward direction response (becomes an on state). The response voltage Vd of the protection diode D2 is substantially equal to the response voltage of the protection transistor in the forward direction response. Accordingly, as indicated with a hidden line in FIG. 7, the voltage pulse thus applied is discharged to the node 18 from the protection diode D2 through the node 26.

As described above, the resistor R1 has a high resistivity, so that a voltage of the node 18 increases and exceeds that of the node 20. Accordingly, the PMOS transistor P3 responds with the voltage Vthp as the forward direction response (becomes the on state). As a result, the voltage pulse thus applied is discharged to the GND terminal 14 from the source terminal through the drain terminal of the PMOS transistor P3. At this moment, the response voltage becomes a sum of the response voltage Vd and the response voltage Vthp. Accordingly, it is possible to respond with a voltage smaller than the response voltage V1n of the NMOS transistor N1 in the reverse direction response.

When a voltage pulse with a negative polarity is applied to the input terminal 10 with the power source terminal 12 at the ground potential, the protection diode D3 responds with the voltage Vd as the forward direction response (becomes an on state). The response voltage Vd of the protection diode D2 is substantially equal to the response voltage of the protection transistor in the forward direction response. Accordingly, as indicated with a projected line in FIG. 7, the voltage pulse thus applied is discharged to the node 22 from the protection diode D3 through the node 28.

As described above, the resistor R3 has a high resistivity, so that a voltage of the node 22 increases and exceeds that of the node 24. Accordingly, the NMOS transistor N3 responds with the voltage Vthn as the forward direction response (becomes the on state). As a result, the voltage pulse thus applied is discharged to the power source terminal 12 from the source terminal through the drain terminal of the NMOS transistor N3. At this moment, the response voltage becomes the sum of the response voltage Vd and the response voltage Vthp. Accordingly, it is possible to respond with a voltage smaller than the response voltage V1p of the PMOS transistor P1 in the reverse direction response.

As described above, in the embodiment, during the protection operation, in which an excessive voltage is applied to the protection circuit, when the excessive voltage is the voltage pulse with the positive polarity with the GND terminal 14 at the ground potential, a bypass path is formed through the forward direction response of the protection diode D2 and the PMOS transistor P3. Accordingly, it is possible to discharge the voltage pulse with a low response voltage, i.e., the sum of the response voltages of the protection diode D2 and the PMOS transistor P3.

Further, in the embodiment, during the protection operation, in which an excessive voltage is applied to the protection circuit, when the excessive voltage is the voltage pulse with the negative polarity with the power source terminal 12 at the ground potential, a bypass path is formed through the forward direction response of the protection diode D3 and the NMOS transistor N3. Accordingly, it is possible to discharge the voltage pulse with a low response voltage, i.e., the sum of the response voltages of the protection diode D3 and the NMOS transistor N3.

In either case, with the protection circuit, it is possible to respond with a voltage smaller than the response voltage in the reverse direction response. Accordingly, it is possible to discharge the excessive voltage with a voltage smaller than a withstanding voltage of the transistor of the internal circuit to be protected. As a result, as a thickness of a gate insulation film decreases as a recent trend, it is possible to effectively prevent the gate insulation film of the transistor to be protected from being damaged.

In the first to fourth embodiments, the protection circuit includes the signal input terminal 10, the power source terminal 12, and the GND terminal 14. Alternatively, the signal input terminal 10 may be replaced with a power source terminal for applying another voltage, so that the protection circuit is configured as a protection circuit between different power sources.

The disclosure of Japanese Patent Application No. 2008-205880, filed on Aug. 8, 2008, is incorporated in the application.

While the invention has been explained with reference to the specific embodiments of the invention, the explanation is illustrative and the invention is limited only by the appended claims.

What is claimed is:

1. A protection circuit, comprising:
a first terminal to which a first voltage is applied;
a second terminal to which a second voltage is applied;
a third terminal to which a third voltage is applied;
a first resistor;
a first primary-type transistor including a drain terminal connected to the first terminal, said first primary-type transistor further including a gate terminal, a source terminal, and a bulk terminal each connected to the second terminal, said first primary-type transistor responding to an excessive voltage applied to the first terminal as a forward direction response to discharge the excessive voltage to the second terminal for protecting an internal circuit from the excessive voltage;
a secondary-type transistor including a drain terminal connected to the first terminal, said secondary-type transistor further including a gate terminal, a source terminal, and a bulk terminal each connected to the third terminal, said secondary-type transistor responding to the excessive voltage applied to the first terminal as a forward direction response to discharge the excessive voltage to the third terminal for protecting the internal circuit from the excessive voltage;
a circuit protection element disposed closer to a side of the internal circuit relative to the first primary-type transistor, said circuit protection element including two terminals, one of said terminals being connected to the first terminal and the other one of said terminals being connected to the second terminal through the first resistor, said circuit protection element responding to the excessive voltage applied to the first terminal as a forward direction response to discharge the excessive voltage from the other one of the terminals for protecting the internal circuit from the excessive voltage; and
a second primary-type transistor including a drain terminal connected to the third terminal, said second primary-type transistor further including a source terminal and a bulk terminal each connected to the other one of the terminals of the circuit protection element, said second primary-type transistor discharging the excessive voltage discharged from the circuit protection element to the third terminal for protecting the internal circuit from the excessive voltage.

2. The protection circuit according to claim 1, wherein said protection element is formed a third primary-type transistor, said third primary-type transistor including a drain terminal as the one of the terminals, said third primary-type transistor further including a gate terminal and a source terminal each connected to the second terminal, said third primary-type transistor further including a bulk terminal as the other one of the terminals.

3. The protection circuit according to claim 1, wherein said circuit protection element is formed a protection diode, said protection diode including a p-side terminal as the one of the terminals, said protection diode further including an n-side terminal as the other one of the terminals.

4. A protection circuit, comprising:
a first terminal to which a first voltage is applied;
a second terminal to which a second voltage is applied;
a third terminal to which a third voltage is applied;
a first resistor;
a second resistor;
a first PMOS transistor including a drain terminal connected to the first terminal, said first PMOS transistor further including a gate terminal, a source terminal, and a bulk terminal each connected to the second terminal, said first PMOS transistor responding to an excessive voltage applied to the first terminal as a forward direction response to discharge the excessive voltage to the second terminal for protecting an internal circuit from the excessive voltage;
a first NMOS transistor including a drain terminal connected to the first terminal, said first NMOS transistor further including a gate terminal, a source terminal, and a bulk terminal each connected to the third terminal, said first NMOS transistor responding to the excessive voltage applied to the first terminal as a forward direction response to discharge the excessive voltage to the third terminal for protecting the internal circuit from the excessive voltage;
a second PMOS transistor disposed closer to a side of the internal circuit in parallel to the first PMOS transistor, said second PMOS transistor including a drain terminal connected to the first terminal, said second PMOS transistor further including a gate terminal and a source terminal each connected to the second terminal, said second PMOS transistor further including a bulk terminal connected to the second terminal through the first resistor, said second PMOS transistor responding to the excessive voltage applied to the first terminal as a forward direction response to discharge the excessive voltage from the bulk terminal thereof for protecting the internal circuit from the excessive voltage; and
a third PMOS transistor including a drain terminal connected to the third terminal, said third PMOS transistor further including a source terminal and a bulk terminal each connected to the bulk terminal of the second PMOS transistor, said third PMOS transistor further including a gate terminal connected to the second terminal through the second resistor, said third PMOS transistor discharging the excessive voltage discharged from the bulk terminal of the second PMOS transistor to the third terminal for protecting the internal circuit from the excessive voltage.

5. A protection circuit, comprising:
a first terminal to which a first voltage is applied;
a second terminal to which a second voltage is applied;
a third terminal to which a third voltage is applied;
a first resistor;
a second resistor;
a third resistor;
a fourth resistor;
a first PMOS transistor including a drain terminal connected to the first terminal, said first PMOS transistor further including a gate terminal, a source terminal, and a bulk terminal each connected to the second terminal, said first PMOS transistor responding to an excessive voltage applied to the first terminal as a forward direction response to discharge the excessive voltage to the second terminal for protecting an internal circuit from the excessive voltage;
a first NMOS transistor including a drain terminal connected to the first terminal, said first NMOS transistor further including a gate terminal, a source terminal, and a bulk terminal each connected to the third terminal, said first NMOS transistor responding to the excessive voltage applied to the first terminal as a forward direction response to discharge the excessive voltage to the third terminal for protecting the internal circuit from the excessive voltage;
a second PMOS transistor disposed closer to a side of the internal circuit in parallel to the first PMOS transistor, said second PMOS transistor including a drain terminal connected to the first terminal, said second PMOS transistor further including a gate terminal and a source terminal each connected to the second terminal, said second PMOS transistor further including a bulk terminal connected to the second terminal through the first resistor, said second PMOS transistor responding to the excessive voltage applied to the first terminal as a forward direction response to discharge the excessive voltage from the bulk terminal thereof for protecting the internal circuit from the excessive voltage;
a third PMOS transistor including a drain terminal connected to the third terminal, said third PMOS transistor further including a source terminal and a bulk terminal each connected to the bulk terminal of the second PMOS transistor, said third PMOS transistor further including a gate terminal connected to the second terminal through the second resistor, said third PMOS transistor discharging the excessive voltage discharged from the bulk terminal of the second PMOS transistor to the third terminal for protecting the internal circuit from the excessive voltage;
a second NMOS transistor disposed closer to a side of the internal circuit in parallel to the first NMOS transistor, said second NMOS transistor including a drain terminal connected to the first terminal, said second NMOS transistor further including a gate terminal and a source terminal each connected to the third terminal, said second NMOS transistor further including a bulk terminal connected to the third terminal through the third resistor, said second NMOS transistor responding to the excessive voltage applied to the first terminal as a forward direction response to discharge the excessive voltage from the bulk terminal thereof for protecting the internal circuit from the excessive voltage; and
a third NMOS transistor including a drain terminal connected to the second terminal, said third NMOS transistor further including a source terminal and a bulk terminal each connected to the bulk terminal of the second NMOS transistor, said third NMOS transistor further including a gate terminal connected to the third terminal through the fourth resistor, said third NMOS transistor discharging the excessive voltage discharged from the bulk terminal of the second NMOS transistor to the second terminal for protecting the internal circuit from the excessive voltage.
